(19) United States
(12) Patent Application Publication
(10) Pub. No.: US 2024/0317586 A1
(43) Pub. Date: Sep. 26, 2024

(54) PREPARATION METHOD OF GRAPHENE CURVED-CARBON LITHIUM-SULFUR BATTERY POSITIVE ELECTRODE MATERIAL

(71) Applicant: Haibo Li, Shenzhen (CN)

(72) Inventor: Haibo Li, Shenzhen (CN)

(21) Appl. No.: 18/387,462

(22) Filed: Nov. 7, 2023

Related U.S. Application Data
(63) Continuation of application No. PCT/CN2023/122427, filed on Sep. 28, 2023.

(30) Foreign Application Priority Data
Mar. 16, 2023 (CN) 202310255198.7
Mar. 24, 2023 (CN) 202310334091.1

(51) Int. Cl. C01B 32/184; C01B 32/198; H01M 4/587

(52) U.S. Cl. CPC C01B 32/184; C01B 32/198; H01M 4/587; C01P 2006/40

(57) ABSTRACT

A preparation method for super-graphene curved-carbon lithium-sulfur battery positive electrode material is provided, including steps of: (1) dispersing a graphene oxide solution evenly and freeze-drying the same, and then performing compressing to obtain a three-dimensional graphene oxide skeleton; (2) heating saccharide and foaming agent to obtain foamed carbon, and then performing ball milling to obtain curved-carbon sheets; (3) soaking the curved-carbon sheets in a Li₂SO₄ solution and dispersing ultrasonically to prepare an aggregate solution of Li₂SO₄ and curved-carbon sheets; (4) soaking the three-dimensional graphene oxide skeleton into the aggregate solution of Li₂SO₄ and curved-carbon sheets for restoration, and then freezing to obtain a precursor; and (5) calcining the precursor under oxygen insulation to obtain the graphene curved-carbon lithium-sulfur battery positive electrode material.

### CROSS-REFERENCE TO RELATED APPLICATIONS

The present application is a Continuation Application of PCT Application No. PCT/CN2023/122427, filed on Sep. 28, 2023, which claims the priority of Chinese Patent Application No. 202310334091.1, filed on Mar. 24, 2023, the entire contents of which are hereby incorporated by reference.

### TECHNICAL FIELD

The present disclosure relates to the technical field of material chemistry, and specifically to a preparation method of super-graphene curved-carbon lithium-sulfur battery positive electrode material.

### DESCRIPTION OF THE PRIOR ART

Lithium-sulfur battery is a new high-energy-density battery, which is developed based on lithium battery by replacing the positive electrode material of the lithium battery with sulfur as the positive electrode material. Compared with traditional lithium batteries, lithium-sulfur batteries have many excellent performances and have good application prospects in many fields.

Lithium-sulfur batteries have benefits of: 1, high specific capacity of 1675 mAh/g, much higher than the capacity of lithium cobalt oxide batteries widely used commercially (about 150 mAh/g), so that more power can be provided for instruments that need to work for a long time: 2, low cost, lower than that of lithium batteries, so that mass production can be achieved, wherein most of the raw materials are natural materials without price fluctuations: 3, good safety, higher than that of traditional lithium batteries, with low-toxic and recyclable.

Although lithium-sulfur batteries have many excellent performances, they still have some shortcomings: 1, volumetric expansion, wherein the lithium-sulfur battery will present large volumetric expansion when charging, which will have a great impact on the life of the battery and affect the battery safety: 2, poor electrical conductivity, which will lead to reduced charging and discharging efficiency, thereby reducing the actual efficiency of the battery: 3, poor sulfur mobility, which will lead to reduced charging efficiency and affect battery efficiency. In summary, the shortcomings of lithium-sulfur batteries mainly include poor conductivity, volumetric expansion, polysulfide shuttle, etc.

Carbon or graphene can be used to overcome the shortcomings of lithium-sulfur batteries. Carbon or graphene has high electrical conductivity, which can improve the conductivity of the battery. By constructing a special structure, the volumetric expansion can be reduced and the safety of the battery can be improved. Further, carbon or graphene has good thermal stability, which can effectively improve charge and discharge cycling stability. However, the existing methods of adding carbon or graphene are difficult to provide enough space to increase the load of sulfur or its related active substances, and to reduce a series of loss and attenuation caused by volumetric expansion of the battery. Further, due to the low product quality or the inability to guarantee the yield rate, mass production cannot be achieved.

### SUMMARY OF THE DISCLOSURE

In view of the problems of poor conductivity, expansion and polysulfide shuttle of lithium-sulfur batteries in the prior art, and to further improve the specific capacity of the batteries, the present disclosure provides a preparation method for super-graphene curved-carbon lithium-sulfur battery positive electrode material, which is simple and suitable for industrial applications.

In order to achieve the above objects, the present disclosure adopts the following technical solutions.

A preparation method for graphene curved-carbon lithium-sulfur battery positive electrode material, comprising steps of:
(1) dispersing a graphene oxide solution evenly and freeze-drying the same, and then performing compressing to obtain a three-dimensional graphene oxide skeleton:
(2) mixing a saccharide and a foaming agent evenly, heating to obtain foamed carbon, and then performing ball milling to obtain curved-carbon sheets:
(3) soaking the curved-carbon sheets in a Li₂SO₄ solution and dispersing ultrasonically to prepare an aggregate solution of Li₂SO₄ and curved-carbon sheets:
(4) soaking the three-dimensional graphene oxide skeleton into the aggregate solution of Li₂SO₄ and curved-carbon sheets for restoration, and then freezing to obtain a precursor; and
(5) calcining the precursor under oxygen insulation to obtain the graphene curved-carbon lithium-sulfur battery positive electrode material.

In step (1), the graphene oxide solution has a concentration ranging from 0.5 g/L to 30 g/L and a compression ratio ranging from 0% to 99%.

In step (2), the foaming agent is selected from at least one of carbonic acid, ammonium carbonate, ammonium chloride, silicon carbide or carbon black. The saccharide is selected from at least one of polysaccharides, oligosaccharides, disaccharides and monosaccharides. Preferably, the saccharide is selected from at least one of starch, chitosan, sucrose and glucose. Preferably, the mass ratio of the saccharide to the foaming agent ranges from 50 g/kg to 8000 g/kg (1:20 to 8:1).

In step (2), the heating temperature and time can be controlled according to the yield, porosity and pore size of the foamed carbon. A wide temperature range can be selected, such as a range from 140° C. to 990° C. It is discovered by testing the performances of the foamed carbon obtained at different temperatures that, the curved-carbon sheets obtained at lower temperatures have a stronger ability to adsorb Li₂SO₄ and are conducive to self-assembly, but the thickness is great, which will affect the load of Li₂SO₄; while the curved-carbon sheets obtained at higher temperatures are thinner, but the adsorption and self-assembly ability will be weakened. Therefore, in order to facilitate subsequent operations and improve the overall performance of the positive electrode material, the preferred temperature is in the range from 150° C. to 800° C.: by testing the electrochemical performances of the batteries assembled from the positive electrode materials prepared by the foamed carbons obtained at different temperatures, the more preferred temperature is in the range from 220° C. to 480° C.

In step (2), the sizes of the curved-carbon sheets are in the range from 0.01 μm to 10 μm.

In step (3), the mass ratio of the curved-carbon sheets to Li₂SO₄ ranges from 0.001 g/kg to 200 g/kg (1:1×10⁶−1:5).

In step (3), in order to increase the loading capacity of Li-ions, the Li₂SO₄ solution is preferably a saturated solution.

In step (4), the three-dimensional graphene oxide skeleton is restored to a natural state, preferably, the restoration time is no more than 5 hours.

In step (4), the mass ratio of the three-dimensional graphene oxide skeleton to the aggregate solution of Li₂SO₄ and curved-carbon sheets ranges from 0.0001 g/kg to 100 g/kg (1:1×10⁶−1:10).

Step (5) further includes preheating at a temperature no more than 110° C. before calcination; the calcination temperature ranges from 500° C. to 900° C.; and preferably, the calcination temperature ranges from 650° C. to 770° C.: a temperature rise rate of the calcination ranges from 0.1° C./min to 10° C./min.

A graphene curved-carbon lithium-sulfur battery positive electrode material is obtained by the above preparation method.

The present disclosure has the following benefits:

According to the preparation method of graphene curved-carbon lithium-sulfur battery positive electrode material of the present disclosure, curved-carbon sheets are constructed to load Li₂SO₄ and filled in the multi-layer skeleton of graphene, and calcinated and compressed to obtain graphene curved-carbon lithium-sulfur battery positive electrode material. The lithium-sulfur active material in the positive electrode material is Li₂S, in some cases, mixing with Li₂O₂ and/or Li₂O. The positive electrode material, by virtue of the three-dimensional space of the curved-carbon sheets, can effectively prevent the volumetric expansion of lithium and sulfur during the cycles, which will lead to battery deformation and damage. The created three-dimensional space has a relatively higher space utilization rate than other methods (such as adding porous carbon, carbon nanotubes, etc.), so the content of loaded lithium and sulfur is also higher. The cladding of the curved-carbon sheets can reduce the diffusion of intermediate polysulfides, improving the stability of charge and discharge cycles. Further, the curved-carbon sheets can significantly increase the electrical conductivity and improve the energy density of the material. The multi-layer structure of graphene can fix the curved-carbon sheets and the positive electrode material to further reduce the shuttle effect. This method is not limited by the sizes of raw materials, and can yield products of large sizes, to meet industrial requirements.

The products prepared by this method can effectively enhance the strength of lithium-sulfur batteries, and reduce the shuttle effect by the curved-carbon sheets and the multi-layer structures of graphene; and compared with porous carbon, carbon nanotubes and other carbon materials, curved-carbon sheets can provide more space for the load of the lithium-sulfur active material while avoiding safety issues caused by battery expansion. Further, carbon materials are easy to conduct electricity, which improves battery performances. Meanwhile, graphene materials are resistant to high temperatures and avoid safety hazards caused by high-speed charging and discharging. This method is simple to conduct and is not limited by the sizes of the raw materials, and can meet the requirements of industrial large-scale production and the size of the final product can be 10 m×10 m. The graphene curved-carbon lithium-sulfur battery positive electrode material has an initial specific capacity as high as 1129.2 mA/g Li₂S (i.e. 1618.2 mAH/g S), more than 85% of which can be maintained after 300 cycles.

### BRIEF DESCRIPTION OF DRAWINGS

The patent or application file contains at least one drawing executed in color. Copies of this patent or patent application publication with color drawing(s) will be provided by the Office upon request and payment of the necessary fec.

FIG. 1 is a schematic diagram of the preparation process of graphene/curved-carbon lithium-sulfur battery positive electrode material:

FIG. 2A is an SEM image of the graphene/curved-carbon lithium-sulfur battery positive electrode material prepared in Example 1: FIG. 2B is an EDS layered image thereof: FIG. 2C shows the carbon element distribution thereof: FIG. 2D shows the sulfur element distribution thereof; wherein scale bars of these images are all 2.5 μm:

FIG. 3A is an SEM image of the graphene/curved-carbon lithium-sulfur battery positive electrode material prepared in Example 2: FIG. 3B is an EDS layered image thereof: FIG. 3C shows the carbon element distribution thereof; FIG. 3D shows the sulfur element distribution thereof: wherein FIG. 3A and FIG. 3B have the same scale bar of 3 μm, FIG. 3C and FIG. 3D have the same scale bar of 10 μm; and

FIG. 4A is an SEM image of the graphene/curved-carbon lithium-sulfur battery positive electrode material prepared in Example 3: FIG. 4B is an EDS layered image thereof: FIG. 4C shows the carbon element distribution thereof: FIG. 4D shows the sulfur element distribution thereof: wherein FIG. 4A and FIG. 4B have the same scale bar of 1 μm, FIG. 4C and FIG. 4D have the same scale bar of 10 μm.

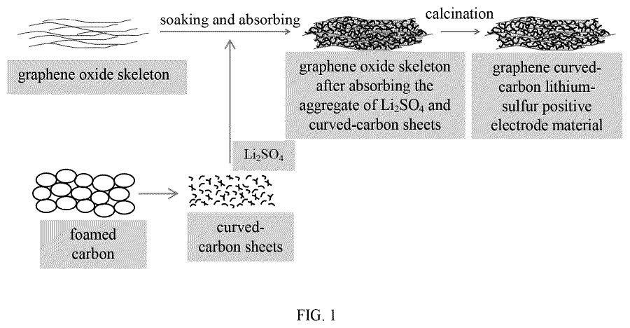

### DESCRIPTION OF EMBODIMENTS

The present disclosure will be further described below with reference to the examples and drawings, but the present disclosure is not limited by the following examples.

Example 1 Preparation of graphene curved-carbon lithium-sulfur battery positive electrode material
(1) 15 g/L high-concentration graphene oxide solution was dispersed evenly and quickly freeze-dried, and compressed by 60% after freeze-drying to form a three-dimensional graphene oxide skeleton:
(2) 4 g/L chitosan solution and 2 g/L carbonic acid solution (the mass ratio of chitosan to carbonic acid is 2:1) were mixed evenly and placed into a mold, and heated to 220° C. in a muffle furnace for foaming and carbonization: the foamed carbon was moved into a ball mill for ball milling for 60 minutes, sieved with a 325 mesh sieve, with the undersize being micron-level curved-carbon sheets:
(3) The above curved-carbon sheets were soaked in a saturated solution of Li₂SO₄ with the mass ratio of the curved-carbon sheets to Li₂SO₄ being 1:500, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:1200), so that it can fully absorb the solution for restoration: after restoration for 2 hours, it was quickly frozen with liquid nitrogen to obtain the precursor:
(5) The muffle furnace was preheated to 110° C., and then the precursor was transferred to the muffle furnace for calcination, with the temperature being gradually raised to 670° C. at a rate of 2° C./min under helium protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 920.3 mAH/g Li₂S, 91% of which was still maintained after 300 cycles (see Table 1 for details), and the energy density can reach 1600 Wh/kg, which is 7 to 8 times the energy density of existing industrially produced ternary lithium batteries (about 200 Wh/kg).

Example 2 Preparation of graphene curved-carbon lithium-sulfur battery positive electrode material
(1) 0.5 g/L high-concentration graphene oxide solution was dispersed evenly and quickly freeze-dried, and compressed by 70% after freeze-drying to form a three-dimensional graphene oxide skeleton:
(2) 4 g/L chitosan solution and 2 g/L ammonium carbonate solution (the mass ratio of chitosan to ammonium carbonate is 1.2:1) were mixed evenly and placed into a mold, and heated to 200° C. in a muffle furnace for foaming and carbonization: the foamed carbon was moved into a ball mill for ball milling for 60 minutes, sieved with a 1000 mesh sieve, with the undersize being micron-level curved-carbon sheets:
(3) The above curved-carbon sheets were soaked in a saturated solution of Li₂SO₄ with the mass ratio of the curved-carbon sheets to Li₂SO₄ being 1:1000, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:100), so that it can fully absorb the solution for restoration; after restoration for 2 hours, it was quickly frozen with liquid nitrogen to obtain the precursor:
(5) The muffle furnace was preheated to 110° C., and then the precursor was transferred to the muffle furnace for calcination, with the temperature being gradually raised to 720° C. at a rate of 5° C./min under argon protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 870.0 mAH/g Li₂S, 92% of which was still maintained after 300 cycles (see Table 1 for details).

Example 3 Preparation of graphene curved-carbon lithium-sulfur battery positive electrode material
(1) 30 g/L high-concentration graphene oxide solution was dispersed evenly and quickly freeze-dried, and compressed by 96% after freeze-drying to form a three-dimensional graphene oxide skeleton:
(2) 1 g/L chitosan solution and 2 g/L ammonium chloride solution (the mass ratio of chitosan to ammonium chloride is 1:20) were mixed evenly and placed into a mold, and heated to 460° C. in a muffle furnace under nitrogen protection for foaming and carbonization: the foamed carbon was moved into a ball mill for ball milling for 60 minutes, sieved with a 10000 mesh sieve, with the undersize being micron-level curved-carbon sheets:
(3) The above curved-carbon sheets were soaked in a saturated solution of Li₂SO₄ with the mass ratio of the curved-carbon sheets to Li₂SO₄ being 1:5, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:20), so that it can fully absorb the solution for restoration; after restoration for 4 hours, it was quickly frozen with liquid nitrogen to obtain the precursor:
(5) The muffle furnace was preheated to 80° C., and then the precursor was transferred to the muffle furnace for calcination, with the temperature being gradually raised to 900° C. at a rate of 10° C./min under argon protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 1061.2 mAH/g Li₂S, 86% of which was still maintained after 300 cycles (see Table 1 for details).

Example 4 Preparation of graphene curved-carbon lithium-sulfur battery positive electrode material
(1) 30 g/L high-concentration graphene oxide solution was dispersed evenly and quickly freeze-dried, and compressed by 96% after freeze-drying to form a three-dimensional graphene oxide skeleton:
(2) 1 g/L chitosan solution and 2 g/L carbonic acid solution (the mass ratio of chitosan to carbonic acid is 1:4) were mixed evenly and placed into a mold, and heated to 380° C. in a muffle furnace under nitrogen protection for foaming and carbonization: the foamed carbon was moved into a ball mill for ball milling for 60 minutes, sieved with a 10000 mesh sieve, with the undersize being micron-level curved-carbon sheets:
(3) The above curved-carbon sheets were soaked in a saturated solution of Li₂SO₄ with the mass ratio of the curved-carbon sheets to Li₂SO₄ being 1:5, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:300), so that it can fully absorb the solution for restoration: after restoration for 5 hours, it was quickly frozen with liquid nitrogen to obtain the precursor:
(5) The muffle furnace was preheated to 100° C., and then the precursor was transferred to the muffle furnace for calcination, with the temperature being gradually raised to 770° C. at a rate of 5° C./min under argon protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 1114.8 mAH/g Li₂S, 92% of which was still maintained after 300 cycles (see Table 1 for details).

Example 5 Preparation of graphene curved-carbon lithium-sulfur battery positive electrode material
(1) 30 g/L high-concentration graphene oxide solution was dispersed evenly and quickly freeze-dried, and compressed by 99% after freeze-drying to form a three-dimensional graphene oxide skeleton:
(2) 10 g/L glucose solution and 2 g/L carbonic acid solution (the mass ratio of glucose to carbonic acid is 1:2) were mixed evenly and placed into a mold, and heated to 520° C. in a muffle furnace for foaming and carbonization: the foamed carbon was moved into a ball mill for ball milling for 60 minutes, sieved with a 10000 mesh sieve, with the undersize being micron-level curved-carbon sheets:
(3) The above curved-carbon sheets were soaked in a saturated solution of Li₂SO₄ with the mass ratio of the curved-carbon sheets to Li₂SO₄ being 1:40, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:500), so that it can fully absorb the solution for restoration; after restoration for 5 hours, it was quickly frozen with liquid nitrogen to obtain the precursor:
(5) The muffle furnace was preheated to 100° C., and then the precursor was transferred to the muffle furnace for calcination, with the temperature being gradually raised to 700° C. at a rate of 10° C./min under argon protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 985.5 mAH/g Li₂S, 93.8% of which was still maintained after 300 cycles (see Table 1 for details).

Example 6 Preparation of graphene curved-carbon lithium-sulfur battery positive electrode material
(1) 12 g/L high-concentration graphene oxide solution was dispersed evenly and quickly freeze-dried, and compressed by 1% after freeze-drying to form a three-dimensional graphene oxide skeleton:
(2) 50 g/L sucrose solution and 2 g/L silicon carbide solution (the mass ratio of sucrose to silicon carbide is 8:1) were mixed evenly and placed into a mold, and heated to 990° C. in a muffle furnace for foaming and carbonization: the foamed carbon was moved into a ball mill for ball milling for 720 minutes to obtain curved-carbon sheets with particle size of 0.2 μm:
(3) The above curved-carbon sheets were soaked in a saturated solution of Li₂SO₄ with the mass ratio of the curved-carbon sheets to Li₂SO₄ being 1:180, and dispersed evenly by ultrasonic for self-assembly to prepare an aggregate solution of Li₂SO₄ and curved-carbon sheets:
(4) The three-dimensional graphene oxide skeleton was quickly added to the aggregate solution of Li₂SO₄ and curved-carbon sheets (the mass ratio of the three-dimensional skeleton to the aggregate is 1:10000), so that it can fully absorb the solution for restoration: after restoration for 1 hour, it was quickly frozen with a refrigerator (temperature below 0° C.) to obtain the precursor:
(5) The muffle furnace was preheated to 90° C., and then the precursor was transferred to the muffle furnace for calcination, with the temperature being gradually raised to 900° C. at a rate of 0.5° C./min under argon protection.

After the temperature rise was completed, the product was taken out and compressed to 95% of its original volume to obtain the graphene curved-carbon lithium-sulfur battery positive electrode. After being assembled into a full battery, the initial specific capacity was measured by electrochemical methods at 1129.2 mAH/g Li₂S, 91.8% of which was still maintained after 300 cycles (see Table 1 for details).

### Comparative Example 1 Preparation of Graphene Oxide-Porous Carbon/Sulfur Composite Material

Graphene oxide-porous carbon/sulfur composite material was prepared according to the method disclosed in “Preparation of High Porosity Graphene Oxide-porous Carbon Composite Material and Application in Lithium-Sulfur Battery” (Chen Xingbu, 2019):
(1) 15 g of sodium chloride was taken and dissolved in 400 mL of deionized water, then 50 mL of graphite oxide dispersion (5.0 mg/mL) and 5 mg of glucose were added into the sodium chloride solution. Then the mixed solution was sonicated for 5 minutes, in a cycle of on for 3 seconds and off for 2 seconds, with a power ratio of 60%, to thoroughly mix the mixed solution. The mixed solution was then freeze-dried for 36 hours. After powder pressing, the mixture was placed in a quartz tube furnace and calcined under the protection of an argon atmosphere (200 mL/min) to carbonize the glucose to generate porous carbon in situ. In the tube furnace, the sample was first heated from room temperature to 600° C. for 1 h, and then calcined at 600° C. for 30 min. In the end, the mixture was soaked in deionized water to leach out the sodium chloride, and then the solution was filtered to remove the sodium chloride. The resulting mixture was freeze-dried again to obtain graphene oxide-porous carbon (GO-PC):
(2) The GO-PC composite powder and nano-sized sulfur (S) powder were respectively taken with a mass ratio of 1:3. After grinding and mixing for 20 minutes, the mixture was placed into a small quartz cup and then in a quartz tube furnace, annealed at 150° C. for 12 hours to allow nano sulfur particles to penetrate into the GO-PC composite material, to obtain the graphene oxide—porous carbon/sulfur (GO-PC/S) composite material.

### Application Example 1 Application of Graphene Curved-Carbon Lithium-Sulfur Battery Positive Electrode Material in Lithium-Sulfur Battery

The batteries were assembled according to the method disclosed in “Preparation of High Porosity Graphene Oxide-porous Carbon Composite Material and Application in Lithium-Sulfur Battery” (Chen Xingbu, 2019):
(1) The composite material in Examples 1-3 or Comparative Example 1 and adhesive of polyvinylidene fluoride were taken respectively with a mass ratio of 8:1, then dispersed in N-methyl-pyrrolidone, stirred and mixed to form a slurry, which was applied on an aluminum foil and dried to obtain an electrode sheet:
(2) A CR2025 battery shell was used, a Celgard 2325 porous polyolefin separator was used as the separator, 1.0 M of LiTFSI lithium-sulfur battery electrolyte (DOL:DME=1:1 Vol %: 1.0% LiNO₃) was used as the electrolyte, a metal lithium sheet was the negative electrode, and the electrode sheet prepared in above step (1) was used as the positive electrode. In the battery assembly, 10 μL of lithium-sulfur battery electrolyte was added, and a nickel foam sheet was placed between the lithium negative electrode and the negative battery shell. After pressing, sealing and drying, the battery assembly was completed.

The above different batteries were tested for electrochemical performance, with a scan rate of 0.1 mV/S for the cyclic voltammetry, and a potential range of 1.5 V to 2.8 V. The batteries were subjected to galvanostatic charge and discharge tests at different current densities. The current density was denoted by rate (C), wherein 1 C=1675 mA/g.

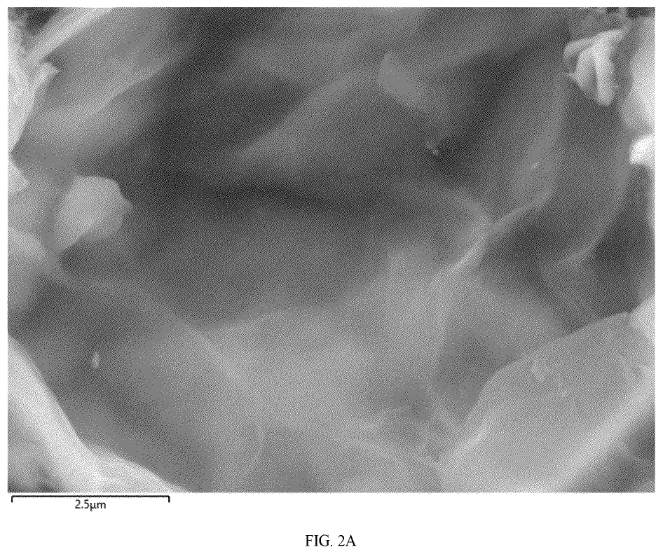

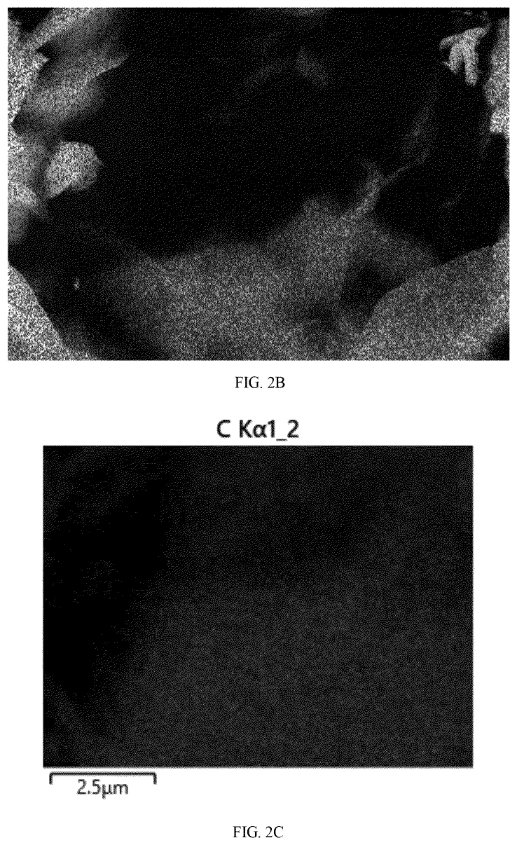

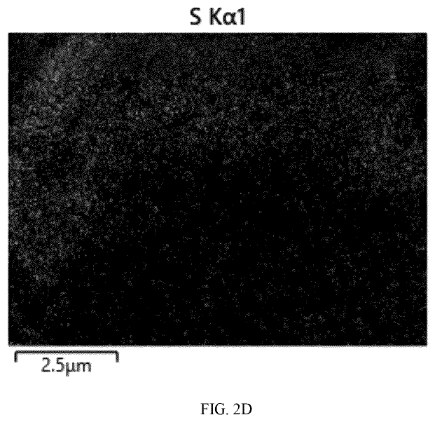

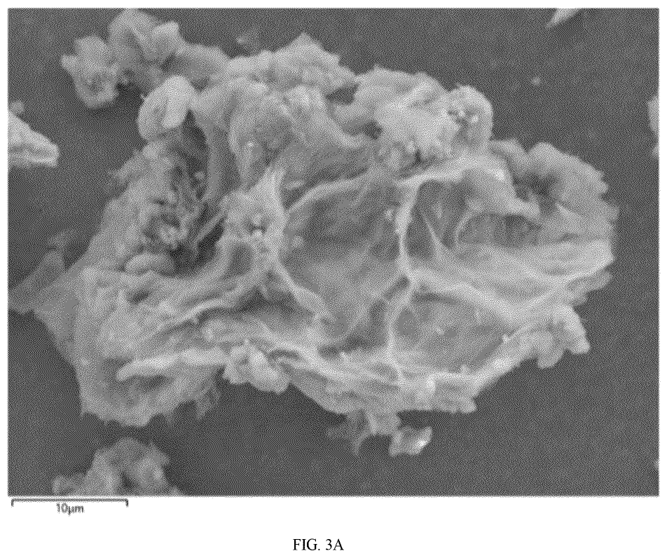

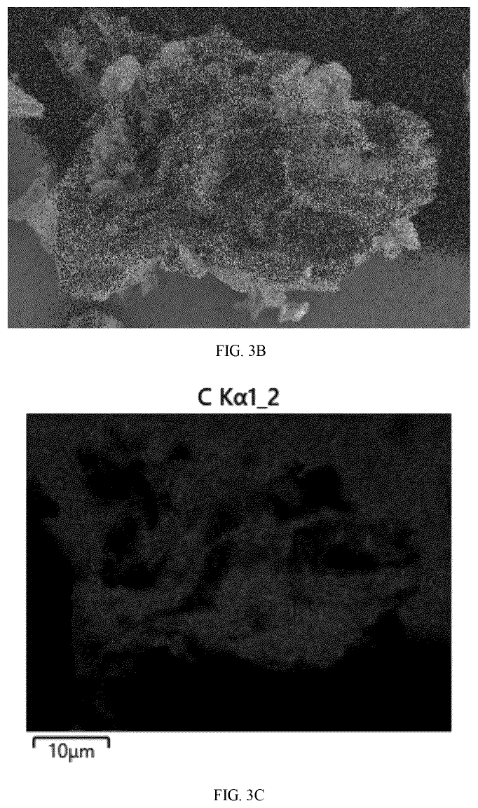

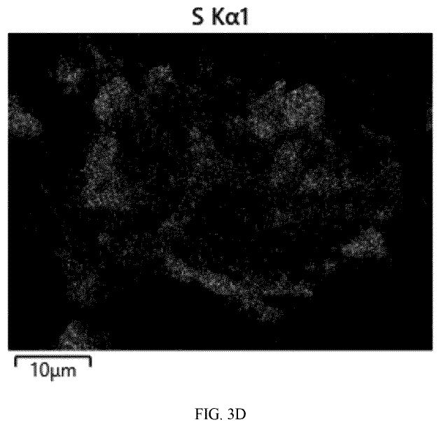

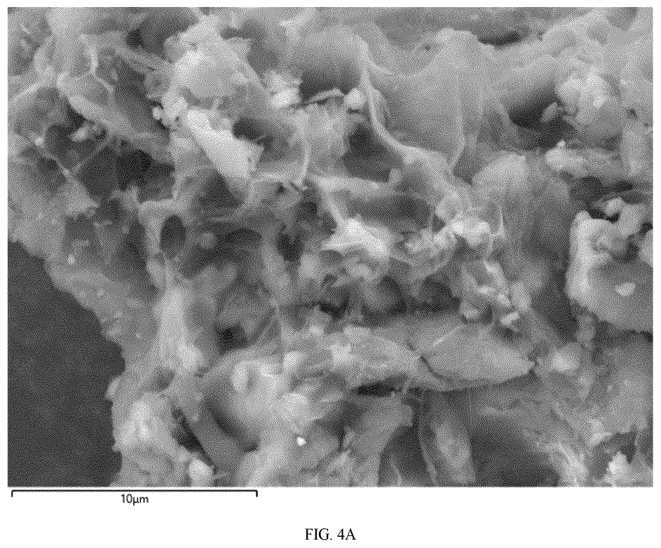

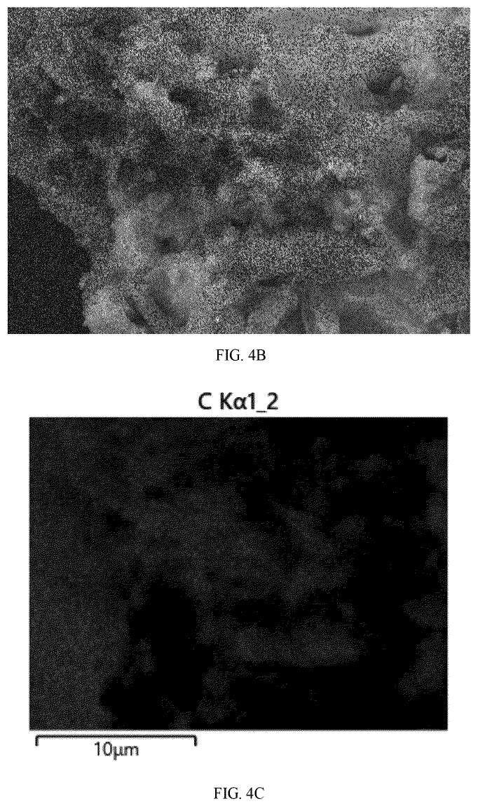

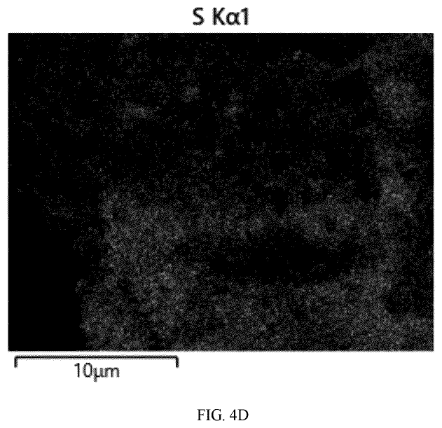

The measurement results of the above batteries are shown in Table 1. The graphene/curved-carbon lithium-sulfur battery has a higher specific capacity when discharged for the first time, and the battery can still maintain a high specific capacity after 300 cycles of charge and discharge. Compared with the porous carbon in Comparative Example 1, the space utilization of the curved-carbon sheets is higher. Because the curved-carbon sheets can form more voids (FIG. 2A, FIG. 3A and FIG. 4A), and different from the porous carbon, the curved-carbon sheets have open structures (FIG. 2), with small interface resistance, into which the active materials are easy to diffuse and fill, the content of loaded sulfur active materials is higher. Further, when the graphene layer is compressed, the curved-carbon sheets will be effectively encapsulated (FIG. 3 B and FIG. 4 B), preventing the diffusion of active material of intermediate polysulfide, to obtain higher cycle efficiency.

TABLE 1
Electrochemical properties of different positive electrode materials

| | Specific capacity | | Specific capacity | |
|---|---|---|---|---|
| | (mAh/g, based on Li₂S, rate 1 C) | | (mAh/g, based on S, rate 1 C) | |
| Example 1 | first discharge | 920.3 | first discharge | 1319.3 |
| | discharge after 300 cycles | 837.5 | discharge after 300 cycles | 1200.8 |
| Example 2 | first discharge | 870.0 | first discharge | 1147.4 |
| | discharge after 300 cycles | 800.6 | discharge after 300 cycles | 1056.2 |
| Example 3 | first discharge | 1061.2 | first discharge | 1521.1 |
| | discharge after 300 cycles | 912.5 | discharge after 300 cycles | 1308.1 |
| Example 4 | first discharge | 1114.8 | first discharge | 1598.2 |
| | discharge after 300 cycles | 1032.9 | discharge after 300 cycles | 1480.9 |
| Example 5 | first discharge | 985.5 | first discharge | 1412.2 |
| | discharge after 300 cycles | 925.1 | discharge after 300 cycles | 1325.7 |
| Example 6 | first discharge | 1129.2 | first discharge | 1618.2 |
| | discharge after 300 cycles | 1037.1 | discharge after 300 cycles | 1486.2 |
| Comparative | first discharge | — | first discharge | 1036.2 |
| example 1 | discharge after 300 cycles | — | discharge after 300 cycles | 500.6 |

### Application Example 2 Application of Graphene Curved-Carbon Lithium-Sulfur Battery Positive Electrode Material in Lithium-Sulfur Battery

The battery was assembled according to the method in Application Example 1, except that step (1) was modified, wherein a conductive agent was added and the proportions of the substances were changed, without modifying the other steps.

The modifications on step (1) are as follows: the composite material in Example 3, adhesive of polyvinylidene fluoride and conductive agent of Ketjen Black were taken respectively with a mass ratio of 8:1:1, and then dispersed in N-methyl-pyrrolidone, stirred and mixed to form a slurry, which was applied on an aluminum foil and dried to obtain a positive electrode sheet.

### Application Example 3 Application of Graphene Curved-Carbon Lithium-Sulfur Battery Positive Electrode Material in Lithium-Sulfur Battery

The battery was assembled according to the method in Application Example I using the positive electrode material of Example 3, except that step (2) was modified, wherein the type and proportion of the electrolyte in step (2) were changed, without modifying the other steps.

The modifications on step (2) are as follows: a CR2025 battery shell was used, no separator was required, and an all-solid-state electrolyte was used as the electrolyte. LGPS(Li₁₀GeP₂S₁₂) and LLZO(Li₇La₃Zr₂O₁₂) with a mass ratio of 2:1 were added with 5% adhesive of polyvinylidene fluoride, and then dispersed in N-methyl-pyrrolidone, stirred and mixed to form a slurry. The slurry was dried and tableted to obtain an all-solid-state electrolyte sheet, the total mass of which is 65% of the mass of the positive electrode sheet prepared in step (1). The negative metal lithium sheet and the positive electrode sheet prepared in step (1) were placed at two sides of the all-solid-state electrolyte sheet respectively. In this way, the battery assembly was completed. In the battery assembly, no liquid electrolyte was added, no separator was required, and a nickel foam sheet was placed between the lithium negative electrode and the negative battery shell. After pressing, sealing and drying, the battery assembly was completed.

### Application Example 4 Application of Graphene Curved-Carbon Lithium-Sulfur Battery Positive Electrode Material in Lithium-Sulfur Battery

The battery was assembled according to the method in Application Example 1 using the positive electrode material of Example 3, but step (1) was modified by adding a conductive agent and adjusting the proportions of the substances and removing the aluminum foil current collector, and step (2) was also modified by changing the type and proportion of the electrolyte, without modifying the other steps.

The modifications on step (1) are as follows: the composite materials in Examples 1 to 3, adhesive of polyvinylidene fluoride and conductive agent of silver powder were taken respectively with a mass ratio of 40:5:1, and then dispersed in N-methyl-pyrrolidone, stirred and mixed to form a slurry, which was dried and directly tableted to obtain a positive electrode sheet.

The modifications on step (2) are as follows: a CR2025 battery shell was used, no separator was required, and an all-solid-state electrolyte was used as the electrolyte. LGPS (Li₁₀GeP₂S₁₂) and anhydrous lithium iodide with a mass ratio of 1:1 were added with 5% adhesive of polyvinylidene fluoride, and then dispersed in N-methyl-pyrrolidone, stirred and mixed to form a slurry. The slurry was dried and tableted to obtain an all-solid-state electrolyte sheet, the total mass of which is 50% of the mass of the positive electrode sheet prepared in step (1). The negative metal lithium sheet and the positive electrode sheet prepared in step (1) were placed at two sides of the all-solid-state electrolyte sheet respectively. In this way, the battery assembly was completed. In the battery assembly, no liquid electrolyte was added, no separator was required, and a nickel foam sheet was placed between the lithium negative electrode and the negative battery shell. After pressing, sealing and drying, the battery assembly was completed.

TABLE 2
Electrochemical properties by different battery assembly methods

| | Specific capacity | | Specific capacity | |
|---|---|---|---|---|
| | (mAh/g, based on Li₂S, rate 1 C) | | (mAh/g, based on S, rate 1 C) | |
| Application | first discharge | 1000.1 | first discharge | 1433.5 |
| example 2 | discharge after 300 cycles | 887.9 | discharge after 300 cycles | 1341.8 |
| Application | first discharge | 936.8 | first discharge | 1342.4 |
| example 3 | discharge after 300 cycles | 857.2 | discharge after 300 cycles | 1228.3 |
| Application | first discharge | 682.1 | first discharge | 977.4 |
| example 4 | discharge after 300 cycles | 615.2 | discharge after 300 cycles | 881.6 |
| Comparative | first discharge | — | first discharge | 1036.2 |
| example 1 | discharge after 300 cycles | — | discharge after 300 cycles | 500.6 |

The measurement results of the above batteries are shown in Table 2. By different battery assembly methods, graphene/curved-carbon lithium-sulfur batteries still have high stability and can even be used to prepare all-solid-state-state batteries. Using sulfur as the active material, the specific capacity and stability of lithium-sulfur batteries are significantly better than those reported in the literatures, with specific energy density between 1497 wh/kg and 2436 wh/kg. If the industrial preparation method is used, and considering the mass of the electrolyte, separator, negative electrode, packaging material for the single-cell battery and other materials, after calculation, a liquid lithium-sulfur battery (the mass proportion of lithium sulfide active material is 25%) has a specific capacity density about 425 wh/kg, an all-solid-state lithium-sulfur battery (the mass proportion of lithium sulfide active material is 50%) has a specific capacity density about 579 wh/kg. Compared with existing industrial batteries (the specific energy density of a single cell is in the range from 150 wh/kg to 300 wh/kg), the lithium-sulfur batteries prepared by the present disclosure have significantly higher specific energy densities. Further, higher specific energy density can be achieved by adjusting different reaction conditions and controlling the proportion of the positive active material of lithium sulfide or the respective proportions of other elements such as sulfur, oxygen, carbon and lithium. The specific capacity and specific energy density of the batteries mentioned above can exceed the theoretical values of lithium-sulfur batteries, mainly because the positive electrode material has some similar characteristics to lithium-oxygen batteries.

The core characteristics of the super-graphene curved-carbon lithium-sulfur battery positive electrode material provided by the present disclosure are as follows:1, the positive electrode material contains curved-carbon materials, as shown in FIG. 2A, FIG. 3A and FIG. 4A, similar to petals, lotus leaves, or honeycombs, instead of carbon nanowires, granular carbon, and porous carbon:2, sulfur-containing active materials can be evenly dispersed, and the filling degree of sulfur-containing active materials can be adjusted by adjusting the proportions of the substances, as shown in FIGS. 2C and 2D which show the element distributions, the sulfur element is mainly found in the depressions and folds of the curved carbon, and there are still many vacant sites in the curved carbon:3, the sulfur-containing active material is effectively covered by the curved carbon while also having channels for communicating with the outside (as shown in FIG. 3B and FIG. 4B), which facilitates contact between active materials, as well as contact with other materials such as conductive agents, electrolytes, solid electrolytes, etc. To identify the special structure created by the present disclosure, one easy method is to disperse the positive electrode material by stirring or ultrasonic treatment and then observe it under a microscope.

1. A preparation method for graphene curved-carbon lithium-sulfur battery positive electrode material, comprising steps of:
(1) dispersing a graphene oxide solution evenly and freeze-drying the same, and then performing compressing to obtain a three-dimensional graphene oxide skeleton:
(2) mixing a saccharide and a foaming agent evenly, heating to obtain foamed carbon, and then performing ball milling to obtain curved-carbon sheets:
(3) soaking the curved-carbon sheets in a Li₂SO₄ solution and dispersing ultrasonically to prepare an aggregate solution of Li₂SO₄ and curved-carbon sheets:
(4) soaking the three-dimensional graphene oxide skeleton into the aggregate solution of Li₂SO₄ and curved-carbon sheets for restoration, and then freezing to obtain a precursor; and
(5) calcining the precursor under oxygen insulation to obtain the graphene curved-carbon lithium-sulfur battery positive electrode material.

2. The preparation method according to claim 1, wherein in step (1), the graphene oxide solution has a concentration ranging from 0.5 g/L to 30 g/L and a compression ratio ranging from 0% to 99%.

3. The preparation method according to claim 1, wherein in step (2), the foaming agent is selected from carbonic acid, ammonium carbonate, ammonium chloride, silicon carbide or carbon black:
the saccharide is selected from at least one of polysaccharides, oligosaccharides, disaccharides and monosaccharides; and
a mass ratio of the saccharide to the foaming agent ranges from 50 g/kg to 8000 g/kg.

4. The preparation method according to claim 1, wherein the saccharide is selected from at least one of starch, chitosan, sucrose and glucose.

5. The preparation method according to claim 1, wherein in step (2), the heating temperature ranges from 140° C. to 990° C.; and
the curved-carbon sheets have sizes ranging from 0.01 μm to 10 μm.

6. The preparation method according to claim 1, wherein in step (2), the heating temperature ranges from 150° C. to 800° C.

7. The preparation method according to claim 1, wherein in step (2), the heating temperature ranges from 220° C. to 480° C.

8. The preparation method according to claim 1, wherein in step (3), a mass ratio of the curved-carbon sheets to Li₂SO₄ ranges from 0.001 g/kg to 200 g/kg.

9. The preparation method according to claim 1, wherein in step (4), the three-dimensional graphene oxide skeleton is restored to a natural state, and the restoration time is no more than 5 hours.

10. The preparation method according to claim 1, wherein in step (4), a mass ratio of the three-dimensional graphene oxide skeleton to the aggregate solution of Li₂SO₄ and curved-carbon sheets ranges from 0.0001 g/kg to 100 g/kg.

11. The preparation method according to claim 1, wherein step (5) further comprises preheating at a temperature no more than 110° C. before calcination; the calcination temperature ranges from 500° C. to 900° C.; and a temperature rise rate of the calcination ranges from 0.1° C./min to 10° C./min.

12. A graphene curved-carbon lithium-sulfur battery positive electrode material, which is obtained by the preparation method of claim 1.
